(19) United States
(12) Patent Application Publication
(10) Pub. No.: US 2021/0033252 A1
(43) Pub. Date: Feb. 4, 2021

(54) LED LUMINAIRE AND A MODULAR LUMINAIRE SYSTEM

(71) Applicant: SIGNIFY HOLDING B.V., EINDHOVEN (NL)

(72) Inventors: MIN CHEN, EINDHOVEN (NL); LEI SUI, EINDHOVEN (NL); QIN LI, EINDHOVEN (NL); LEON ZHOU, EINDHOVEN (NL); LINDA LUO, EINDHOVEN (NL)

(21) Appl. No.: 17/045,900

(22) PCT Filed: Apr. 9, 2019
(86) PCT No.: PCT/EP2019/058897

§ 371 Date: Oct. 7, 2020

(30) Foreign Application Priority Data
Apr. 12, 2018 (CN) PCT/CN2018/082786
May 14, 2018 (EP) 18172080.6

(51) Int. Cl. F21S 8/08; F21V 15/01; F21V 15/015

(52) U.S. Cl. CPC F21S 8/086; F21Y 2103/37; F21V 15/015; F21V 15/013

(57) ABSTRACT

The invention provides a LED luminaire comprising a frame shape formed of straight arms (12, 20) which each carry an LED arrangement (18, 26), and connections (30) which provide mechanical connection between the support arms (12, 20) and electrical connection between the LED arrangements (18, 26) of those arms (12, 20). The frame shape has a central opening (25) which assists cooling by convection and it can be manufactured using a low cost extrusion process.

### FIELD OF THE INVENTION

This invention relates to LED luminaires.

### BACKGROUND OF THE INVENTION

LED luminaires are increasingly replacing conventional luminaires, such as based on fluorescent lighting. One example is road lighting luminaires.

Normally, LED road lighting luminaires make use of a large and heavy die cast housing. The purpose is to provide sufficient heat dissipation capability as well as a certain strength to protect the luminaire from impact.

The light distribution from a road luminaire must match strict conditions, which mean that an optical lens is also required. For example, a typical LED road lighting luminaire uses a so-called “peanut lens” (which is a dome shaped lens with a central waist) over each LED chip to realize the required light distribution.

To match each LED chip with one lens, the LEDs must be placed sparsely which makes the LED board very big. Consequently, the lens and housing are large, which has cost implications as well as making the luminaire large and heavy. If the lens is fabricated by injection molding, a large required size results in more difficult and expensive manufacture.

There is also a problem that different luminaire requirements, such as lighting power, require different sizes of the luminaire, with different die casting and injection molding tooling.

US 2013/0135857 discloses a LED road lamp in which LEDs are provided on tubular bodies extending from a seat body. They may take the form of U-shaped tubular bodies with air flow through the spaces between the tubular bodies to provide improved heat dissipation. However, this structure is expensive to manufacture and it is difficult to scale the design to different requirements.

US 2017/0268759 discloses a curved LED tubular lamp, which includes a curved lamp tube having two straight segments and a curve segment disposed between the two straight segments; at least one flexible substrate having a plurality of LEDs mounted thereon, and at least one positioning pillar formed on the inner surface of the curve segment of the curved lamp tube, wherein each of the two straight segments and the curve segment have LEDs disposed therein, and wherein the flexible substrate is disposed in at least the curve segment.

US 2013/0235570 discloses a light emitting device comprises two tubes comprising linear arrays of light emitting diodes physically coupled by a third tube. The third tube comprises a linear array of light emitting diodes. The first tube, second tube, and third tube of the light emitting device are positioned to substantially form the shape of a character “U” in a plane perpendicular to the optical axis. The first linear array of light emitting diodes has an average spacing between the light emitting diodes, and a ratio of the first, shorter dimension of the light emitting diodes to the average spacing is between 1 and 3.

US 2015/0345755 discloses an LED linear lamp assemblage. The assemblage has two LED linear lamp sections, each LED linear lamp section with an elongated tube with a transparent or translucent cover that connects to the base portion that defines a space inside. A circuit board with a plurality of spaced apart LEDs and electrical connectors are disposed within the space. At first ends of the two LED linear lamp sections are pin(s) for connecting to a power source, and the electrical connectors are located near second ends of each LED linear lamp section. A joiner unit is provided for mechanically connecting and holding the two LED linear lamps sections together at their second ends. When the two LED linear lamp sections are connected at their second ends to establish electrical connection the LED linear lamp assemblage is complete.

### SUMMARY OF THE INVENTION

The invention is defined by the claims.

According to examples in accordance with an aspect of the invention, there is provided a LED luminaire, comprising:

a LED driver unit;

a first straight support arm extending outwardly from the LED driver unit, having a proximal first end at which the first support arm connects to the LED driver unit and a remote second end;

a first LED arrangement mounted on the first support arm;

a second straight support arm extending outwardly from the LED driver unit, having a proximal first end at which the second support arm connects to the LED driver unit and a remote second end, wherein the first ends are spaced apart;

a second LED arrangement mounted on the second support arm; and

a connecting section between the remote second ends of the first and second support arms which provides mechanical connection between the first and second support arms and electrical connection between the first and second LED arrangements.

This arrangement provides a modular luminaire design in which the LED arrangements are formed on a frame-type structure formed of straight (hence low cost) sections, with electrical and mechanical connections between those sections made by a connecting section. The frame structure together with the driver unit forms a closed shape, giving strength and rigidity. The frame provides an open structure which assists in cooling. The support arms function both as heat sinks and as support structures. The frame design means less material needs to be used to achieve the required cooling, as well as enabling a modular design.

The first and second support arms for example have constant cross sectional shape along their length. This means they can be produced at low cost. The same manufacturing equipment may also be used to form support arms of different length.

The first and second support arms are for example formed of extruded metal. This provides a particularly low cost solution, for example compared to conventional die casting. The first and second support arms may be formed of extruded aluminum.

The connecting section may comprise at least one adapter elbow which fits between support arms.

The adapter elbow provides the coupling between support arms on opposite sides. As a minimum, there is just one adapter elbow between the two support arms, so that together with the LED driver unit, a triangular frame shape is formed. However, elbows and support sections (of different length) may form a modular system which may be used to create different luminaire designs for different situations. There may be multiple elbows and three or more support arms, enabling many different frame shapes to be formed. At least one of the first and second support arms is rotatable within the adapter elbow and the electrical connection to the adapter elbow and the LED driver unit allow relative rotation. Thus, the light output direction may be adjustable.

The at least one adapter elbow for example comprises an injection molded plastic housing or a die cast metal housing.

This provides protection for the internal electrical connections, for example for use in an outdoor luminaire.

In one example, the connecting section comprises two adapter elbows and a third straight support arm extending between the two adapter elbows, with a third LED arrangement mounted on the third support arm. Thus, the electrical connection between the first and second LED arrangements is via the third LED arrangement rather than direct. The three support arms together with the LED driver unit then form a rectangular or trapezium shape, with a central opening which serves as a space for cooling by convection.

Each LED arrangement for example comprises an array of LEDs, with a lens over each LED or a lens plate over the array of LEDs.

The lenses are used to provide beam shaping or steering for a certain light distribution.

The lenses or lens plate may comprise an extruded structure. This provides a low cost solution for the lenses. There may be a lens for each LED or the extruded lens plate may cover a line of LEDs.

The lenses are for example attached over the LED arrangements using a silicon seal. This provides ingress protection to the LED arrangements.

The first and second support arms may lie in a common plane, and the first and second LED arrangements each have a principle light output direction which is angularly spaced from a direction perpendicular to the plane.

By providing the light output deflected away from the conventional orientation (perpendicular to the plane of the support), the light distribution may be tuned. This for example assists the use of extruded lenses, which only permit beam shaping in one plane. The shape formed by the support arms and the orientation of the LED arrangements are together used to define the light output characteristics.

The light output direction may also be adjustable so that the luminaire may be configured to deliver a desired light output distribution. This may for example be achieved by rotating the respective support arm about its elongate axis.

In one application, the luminaire comprises a road lighting luminaire. The LED driver unit then comprises a housing which houses driver circuitry and wherein the housing comprises a lamp post fixing unit.

The invention also provides a modular luminaire system, comprising:

a LED driver unit;

a set of straight support arms with LED arrangements mounted on the support arms; and

a set of adapter elbows for providing mechanical connection between adjacent support arms and electrical connection between LED arrangements of the adjacent support arms,

wherein the modular luminaire system is configurable to create a luminaire as defined above.

This modular system may be used to form different possible luminaire designs, with different sizes and shapes of the frame structure.

At least one of the straight support arms may be rotatable around its elongate axis. This enables adjustment of the light output distribution.

These and other aspects of the invention will be apparent from and elucidated with reference to the embodiment(s) described hereinafter.

### BRIEF DESCRIPTION OF THE DRAWINGS

Examples of the invention will now be described in detail with reference to the accompanying drawings, in which:

FIG. 1 shows a luminaire in perspective view from above;

FIG. 2 shows the luminaire of FIG. 1 in perspective view from below;

FIG. 3 shows a lens arrangement;

FIG. 4 shows the light output distribution from the luminaire; and

FIG. 5 shows some alternative frame shapes to be formed by the luminaire.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a LED luminaire comprising a frame shape formed of straight arms which each carries an LED arrangement, and connections which provide mechanical connection between the support arms and electrical connection between the LED arrangements of those arms. The frame shape has a central opening which assists cooling by convection and it can be manufactured using a low cost extrusion process.

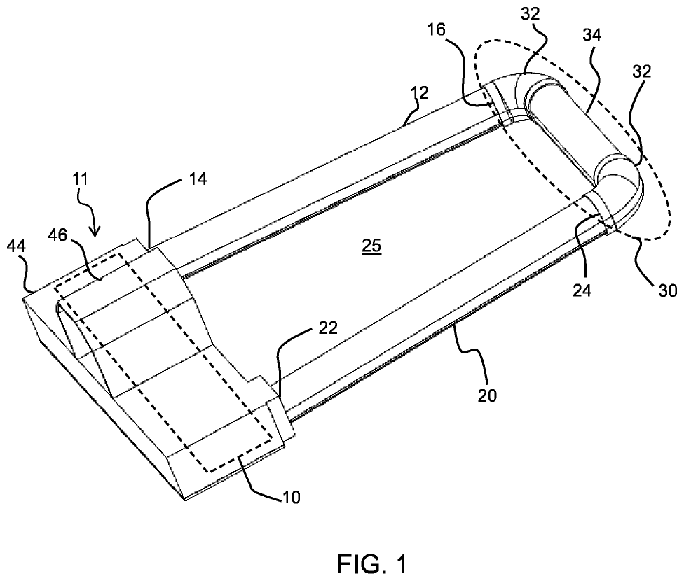

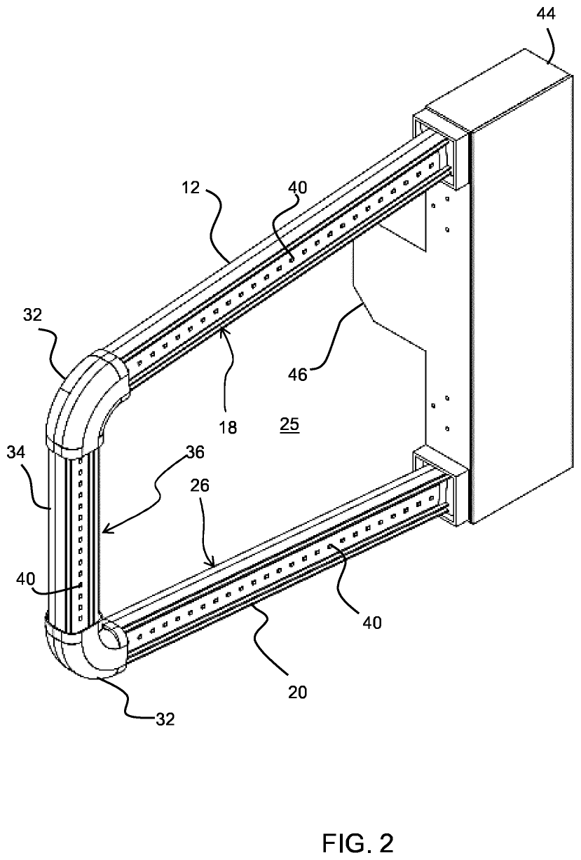

FIG. 1 shows a luminaire in perspective view from above and FIG. 2 shows the luminaire of FIG. 1 in perspective view from below.

As shown in FIG. 1, the luminaire comprises an LED driver 10 within a driver unit 11. The driver unit 11 connects to a first straight support arm 12 extending outwardly from the driver unit 11 and having a proximal first end 14 at which the first support arm 12 connects to the LED driver unit 11, and a remote second end 16. A first LED arrangement is mounted on the first support arm 12, facing downwardly, and hence not visible in FIG. 1.

A second straight support arm 20 extends outwardly from the LED driver unit 11 and has a proximal first end 22 at which the second support arm 20 connects to the LED driver unit 11 and a remote second end 24. The first ends 14,22 are spaced apart so that a central opening 25 is formed. A second LED arrangement is mounted on the second support arm 20, facing downwardly, and hence not visible in FIG. 1.

A connecting section 30 is provided between the remote second ends 16,24 of the first and second support arms. It provides mechanical connection between the first and second support arms 12, 20 and electrical connection between the first and second LED arrangements.

The central opening 25 may be triangular, in which case the connecting section 30 is in the form of a U-bend connector (forming an acute angle). FIG. 1 instead shows a rectangular (or in fact slightly trapezoidal) central opening. The connecting section 30 thus comprises two near 90 degree elbows 32 and a third support arm 34 between them. A third LED arrangement is mounted on the third support arm 34, facing downwardly, and hence not visible in FIG. 1.

The support arms may be manufactured to any length, so that a standard set of elbows may be used to define a modular luminaire design. A frame-type structure is formed from the straight and low cost sections, with electrical and mechanical connections between those sections made by a set of standard elbow connectors. The support arms function both as heat sinks for the supported LED arrangements and as support structures. The frame design means less material needs to be used to achieve the required cooling, as well as enabling a modular design. It also presents a reduced wind resistance compared to a solid design.

The support arms preferably have a constant cross sectional shape along their length which means they can be produced by an extrusion process. The support arms are for example formed of extruded aluminum.

The elbows may comprise an injection molded plastic housing or a die cast metal housing. The elbows provide protection for the internal electrical connections, which is particularly important for an outdoor luminaire.

The driver unit 11 comprises the LED driver, for example a switch mode power supply which performs AC to DC conversion, within an outer housing 44. The outer housing 44 for example has a fitting 46 for attachment to a light pole. The light pole end to which the luminaire is attached for example extends in a horizontal plane, and the plane of the frame of support arms for example lies in a plane which is oriented horizontally, in use.

FIG. 2 shows the first, second and third LED arrangements 18, 26, 36 of the first, second and third support arms 12, 20, 34 respectively. Each LED arrangement comprises an array of LEDs 40. There may for example be a single line of LEDs 40 attached to each support arm. There is a lens associated with each LED to provide beam shaping and/or steering.

The extruded support arm design is thinner than die casting. Furthermore, the material thermal conductivity is better. Since the support arms are spaced apart to form a frame structure, there is improved thermal convection which further reduces the surface area required for heat dissipation. Overall, the heat sink is smaller and lighter than for a die cast design. In addition, the tooling investment for an extrusion process is much lower than for die casting. When a different lumen package or power level is needed for the luminaire, only the pitch of LEDs or the length of the housing need to be adjusted. Little tooling adjustment or investment is needed, which can further reduce the cost of production and portfolio management.

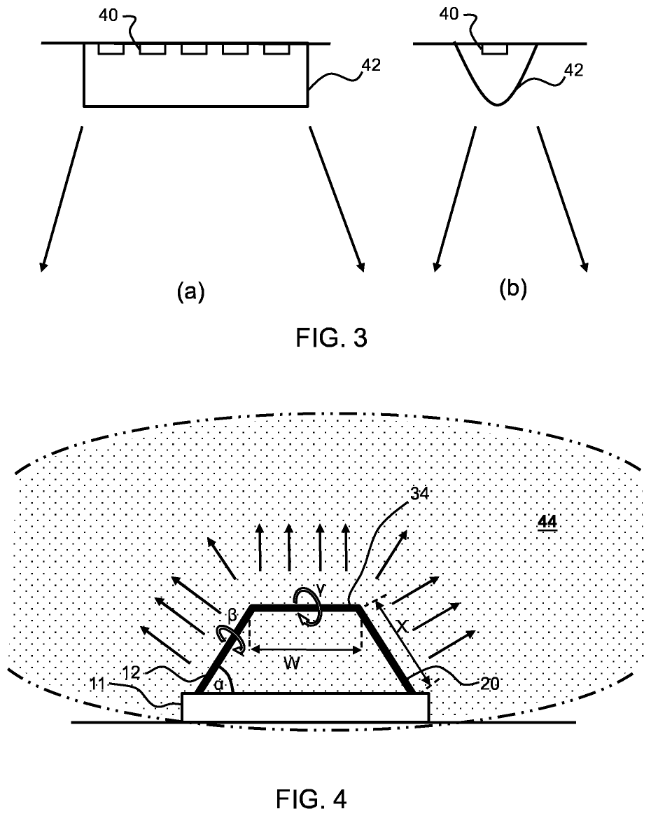

FIG. 3 shows one example of the lens design in side view in FIG. 3(a) and in cross sectional view in FIG. 3(b) perpendicular to a length direction. There is a shared lens plate 42 over the line of LEDs 40. The lens plate has a constant cross section along its length so that it may be formed as an extruded component. This means that beam shaping is only possible in one plane (the cross sectional plane to the right of FIG. 3). There may instead be a lens for each LED but the individual lenses may still be extruded components. The more conventional peanut injection molded lenses may instead be used.

The lenses or lens plate 42 is attached over the LED arrangements using a silicon seal to provide ingress protection to the LED arrangements. An extruded lens design means the LEDs 40 can be arranged much more closely spaced, which makes the design more compact.

FIG. 4 shows a view from above of the luminaire, showing the light output distribution 44, which may for example be the light which illuminates a road beneath a street lamp.

The LED arrangements are arranged with different angles to cover the whole desired light distribution. Parameters which may be varied to alter the light distribution are the length X of the side support arms, the length W of the end support arm, the angle α which forms the trapezium shaped frame, a rotation angle β (for the sides) and a rotation angle γ (for the end) to achieve the desired lighting distribution. Overall, there are thus five parameters which can be tuned to obtain the target light distribution.

The rotation angles mean that the first and second LED arrangements have a principle light output direction which is angularly spaced from a direction perpendicular to the plane of the frame shape. As shown in FIG. 4, the rotation means the principle light output direction is away from the frame shape, to create a larger beam shape on the road surface beneath. The ability to tune the light output distribution in this way enables the use of the simple extruded lenses as shown in FIG. 3. The light output direction may be adjustable, i.e. the angles β and γ may be set during installation. This may simply involve rotating the support arms within the elbow and where they connect to the driver unit 11. This rotation is about the elongate axis of the support arms. The electrical connections to the elbows and to the driver unit thus allow relative rotation.

The luminaire design may be created from a modular luminaire system. The modular system has one or more designs of driver unit, a set of straight support arms, a set of LED arrangements and a set of adapter elbows.

This modular system may be used to form different possible luminaire designs, with different sizes and shapes of the frame structure. When a different lumen package or power level of the luminaire is needed for a particular product, a particular pitch of the LEDs or the length of the housing and lens may be selected. No new tooling investment is needed and the adapters and other components can be re-used.

As mentioned above, the support arms may be formed as extruded aluminum. They may instead be fabricated by other methods such as bending, stamping, etc. The PCB which carries the LED arrangement may be glued or screwed onto the support arm which functions as the heat sink. The lens functions as an optical cover, and it may be glued to the support arm to form the complete housing of the module. The framed is formed using the elbows and support arms, and the frame is then assembled to the driver unit where the driver is contained. The driver unit is then fixed to the light pole.

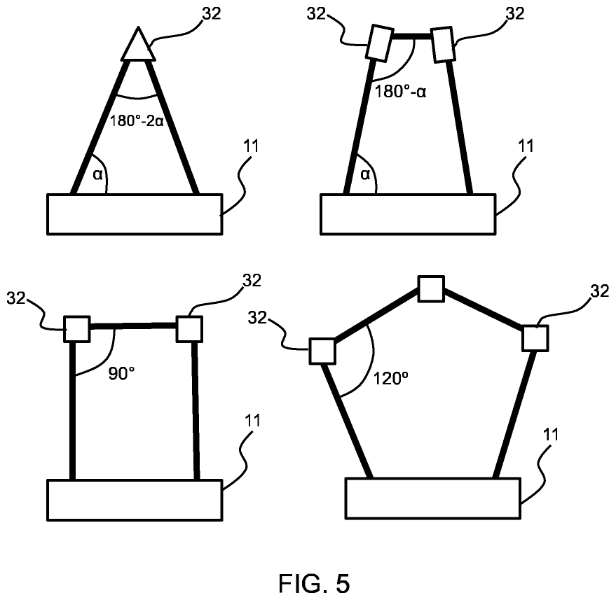

As mentioned above, the modular design enables different frame shapes to be formed. FIG. 5 shows four examples, of:

a triangular opening with only two support arms and one elbow and wherein the elbow has an angle 180°−2α degrees;

a trapezium shaped opening wherein each of the two elbows has an angle of 180°−α degrees;

a rectangular opening with 90 degree elbows; and

a pentagonal opening with 120 degree elbows.

By way of example, the length of the two main (side) support arms may be of the order of tens of centimeters, for example in the range 60 cm to 80 cm.

The length of the third support arm may also be of the order of tens of centimeters, for example in the range 20 cm to 50 cm and the angle α which defines the degree by which the frame shape deviates from a rectangle to a trapezium may be in the range 45 to 90 degrees.

The LEDs are formed as discrete LED chips for example carried on a printed circuit board which is then mounted to the support art. The printed circuit board can have a simple regular shape. The LED chips are for example spaced by a distance in the range of 2 mm to 10 mm.

Each LED chip for example has a power in the range of 0.5 W to 2 W and there are typically in the range 60 to 150 LEDs on each support arm.

One example of a use of the invention as a street light has been given above. However, the invention is of interest generally for other high power luminaires whose light distribution can be generated by aforementioned modularized frame structure such as high bay luminaires.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A LED luminaire, comprising:
a LED driver unit;
a first straight support arm extending outwardly from the LED driver unit, having a proximal first end at which the first support arm connects to the LED driver unit and a remote second end;
a first LED arrangement mounted on the first support arm;
a second straight support arm extending outwardly from the LED driver unit, having a proximal first end at which the second support arm connects to the LED driver unit and a remote second end, wherein the first ends are spaced apart;
a second LED arrangement mounted on the second support arm; and
a connecting section between the remote second ends of the first and second support arms which provides mechanical connection between the first and second support arms and electrical connection between the first and second LED arrangements;
wherein the first and second support arms have constant cross sectional shape along their length;
wherein the connecting section comprises at least one adapter elbow which fits between support arms;
wherein at least one of the first and second support arms is rotatable within the adapter elbow and the electrical connection to the adapter elbow and the LED driver unit allow relative rotation.

2. A luminaire as claimed in claim 1, wherein the first and second support arms are formed of extruded metal.

3. A luminaire as claimed in claim 2, wherein the first and second support arms are formed of extruded aluminum.

4. A luminaire as claimed in claim 1, wherein the at least one adapter elbow comprises an injection molded housing or a die cast metal housing.

5. A luminaire as claimed in claim 1, wherein the connecting section comprises two adapter elbows and a third straight support arm extending between the two adapter elbows, with a third LED arrangement mounted on the third support arm.

6. A luminaire as claimed in claim 1, wherein each LED arrangement comprises an array of LEDs, with a lens over each LED or a lens plate over the array of LEDs.

7. A luminaire as claimed in claim 6, wherein the lenses or lens plate comprise an extruded structure.

8. A luminaire as claimed in claim 6, wherein the lenses or lens plate are attached over the LED arrangements using a silicon seal.

9. A luminaire as claimed in claim 1, wherein the first and second support arms lie in a common plane, and wherein the first and second LED arrangements each have a principle light output direction which is angularly spaced from a direction perpendicular to the plane.

10. A luminaire as claimed in claim 1, comprising a road lighting luminaire.

11. A luminaire as claimed in claim 10, wherein the LED driver unit comprises a housing which houses driver circuitry, wherein the housing comprises a lamp post fixing unit.

12. A modular luminaire system, comprising:
a LED driver unit;
a set of straight support arms with LED arrangements mounted on the support arms; and
a set of adapter elbows for providing mechanical connection between adjacent support arms and electrical connection between LED arrangements of the adjacent support arms,
wherein the modular luminaire system is configurable to create a luminaire as claimed in claim 1.

13. A modular luminaire system as claimed in claim 12, wherein at least one of the straight support arms is rotatable around its elongate axis.
